(19) United States
(12) Patent Application Publication
(10) Pub. No.: US 2026/0268345 A1
(43) Pub. Date: Sep. 10, 2026

(54) METHODS AND SYSTEMS FOR DETERMINING THE AUTHENTICITY OF A COMPONENT

(71) Applicant: LEXMARK INTERNATIONAL, INC., LEXINGTON, KY (US)

(72) Inventors: STEPHEN PORTER BUSH, RICHMOND, KY (US); JAKE DARYLL OBINA, CEBU CITY (PH); NORMANDO SALVADOR PUMAR, MANDAUE CITY CEBU (PH); MARVIN ALIVIADO RODRIGUEZ, TALISAY CITY CEBU (PH); CHRISTOPHER GERALD SANTOS, MANDAUE CITY CEBU (PH)

(21) Appl. No.: 19/253,447

(22) Filed: Jun. 27, 2025

Related U.S. Application Data
(60) Provisional application No. 63/768,383, filed on Mar. 7, 2025.

(51) Int. Cl. G06Q 30/018

(52) U.S. Cl. CPC G06Q 30/0185

(57) ABSTRACT

A method of authenticating a supply item installed in an imaging device. The method comprises determining a plurality of feature values of the supply item, each feature value corresponding to a respective feature type, inputting the feature values to a model, and determining the supply item to be authentic based on a comparison of a confidence value with a predetermined threshold. The model comprises a respective weight for each of the feature types and the model is configured to return the confidence value, the confidence value indicating a likelihood that the supply item is authentic. An imaging system, the imaging system comprising an imaging device and a supply item installed in the imaging device. The imaging device stores a model, wherein the model comprises a respective weight for each of a plurality of feature types and the model is configured to return a confidence value, the confidence value indicating a likelihood that the supply item is authentic. The imaging device is configured to authenticate the supply item by: determining a plurality of feature values of the supply item, each feature value corresponding to a respective one of the feature types, inputting the feature values to the model, and determining the supply item to be authentic based on a comparison of the confidence value with a predetermined threshold.

### CROSS REFERENCE TO RELATED APPLICATIONS

This application claims priority and benefit under 35 U.S.C. 119(e) from U.S. provisional application No. 63/768,383 titled “A Machine Learning Approach to Supplies Security and a Self-Authenticating Security Chip,” having a filing date of Mar. 7, 2025.

### BACKGROUND

### 1. Technical Field

The present disclosure generally relates to methods and systems for determining the authenticity of a component, and, more particularly, methods and systems for determining the authenticity of a supply item component within an imaging device.

### 2. Description of the Related Art

In electronic systems, it is often desirable to confirm the authenticity of a component of the electronic system to ensure that the entire system operates as designed. Non-authentic components employ various techniques to mimic the behavior of authentic components. This may include copying the authentic component's circuits and memory contents in order to duplicate authentication algorithms or encrypted communication between the component and the rest of the electronic system. This is particularly important in printing systems where it is desirable to confirm the authenticity of a supply component of the printing system to ensure correct operation.

Non-authentic components may utilize different resources than an authentic component in order to accomplish similar behavior. For example, an encryption scheme done via a hardware circuit on the authentic component may be implemented on a non-authentic component via firmware running on a programmable microcontroller. This makes it easier to produce a non-authentic component which passes as an authentic component.

Accordingly, there is a need for improved systems and methods for determining the authenticity of a component to thwart the use of non-authentic components.

### SUMMARY

The present disclosure provides example methods and systems that may be implemented in any general electronic system or specifically in an imaging/printing device/system to thwart the use of non-authentic components.

There is provided a method of authenticating a supply item installed in an imaging device, the method comprising: determining a plurality of feature values of the supply item, each feature value corresponding to a respective feature type, inputting the feature values to a model, wherein the model comprises a respective weight for each of the feature types and the model is configured to return a confidence value, the confidence value indicating a likelihood that the supply item is authentic, and determining the supply item to be authentic based on a comparison of the confidence value with a predetermined threshold.

In certain implementations, the confidence value is greater when the likelihood of authenticity is greater. In this case, when the confidence value meets or exceeds the threshold, the supply item is determined to be authentic. Alternatively, in certain implementations, the confidence value is lower when the likelihood of authenticity is greater. In this case, when the confidence value is less than the threshold, the supply item is determined to be authentic.

In certain implementations, the confidence value may comprise a label, such as YES/NO, and/or a probability that the supply item is authentic. In certain implementations, when the confidence value is not determined to be authentic, the supply item is determined to be non-authentic and/or further action may be taken, such as initiating further countermeasures to check the authenticity of the supply item. For example, the imaging device may prevent use of the supply item, when it is determined that the supply item is non-authentic.

In certain implementations, the model is a machine learning model, and the method further comprises training the model using training data comprising sets of feature values, wherein each set contains feature values from a single respective supply item. In certain implementations, each set comprises a feature value for each of the feature types. In certain implementations, the feature types each comprise a respective different characteristic, such as a property or test result of the supply item.

In certain implementations, training comprises supervised learning, and/or transfer learning. Training may be performed by a model-training computing device, such as a computer, server, or cloud-based system.

In certain implementations, the training data is generated from real-life testing of supply items. In certain implementations, the training data includes data collected under boundary/edge conditions and/or includes tolerance data. In certain implementations, testing under boundary conditions includes simulating fast and slow corners of the imaging system by adjusting the system capacitance and/or using corner parts of a chip of a security device of the imaging device or supply item. The corner parts represent the extreme edges of the manufacturing process of a silicon device.

In certain implementations, the testing utilizes multiple imaging systems including imaging systems with differing properties, such as age and/or model number and/or functionality. Imaging systems with differing functionality may include (i) single-function and multi function systems, (ii) printers with integrated scanners and printers without integrated scanners, (iii) systems with different print speeds, and (iv) printers with different user interfaces.

In certain implementations, the feature types comprise properties of the supply item. In certain implementations, the properties may comprise any property that can be measured by the imaging device. In certain implementations, the properties comprise one or more electrical properties of the supply item, such as electrical properties of a security chip/device on the supply item. In certain implementations, the feature types comprise feature types unrelated to and/or independent from each other, and/or orthogonal, such as properties of different components, or features which do not interact. An example of a pair of orthogonal features is a power delay and a command response time of the supply item.

In certain implementations, the feature types comprise results of tests performed by the supply item. In certain implementations, the results of tests comprise challenge responses, and/or time taken by the supply item to perform a challenge or test, and/or a soft reset time and/or a time taken to initiate a session. In certain implementations, the feature values are measured by firmware on the imaging device. In certain implementations, the properties are hardware properties of the supply item. In certain implementations, the properties are analog properties, such as voltage levels or changes in voltage in predetermined circumstances, or time taken for common tasks to be performed. In certain implementations, challenges may be cryptographic challenges, and a corresponding challenge response is a response provided by the supply item in response to the cryptographic challenge.

In certain implementations, authenticating the supply item further comprises: receiving a cryptographic signature from the supply item, verifying the signature with a public key and verifying the model with the signature. In certain implementations, the signature contains an indication of an expected range of feature values for the supply item.

In certain implementations, the method is performed by firmware on the imaging device and/or supply item.

There is further provided an imaging system, the imaging system comprising an imaging device and a supply item installed in the imaging device, wherein the imaging device stores a model, wherein the model comprises a respective weight for each of a plurality of feature types and the model is configured to return a confidence value, the confidence value indicating a likelihood that the supply item is authentic, and the imaging device is configured to authenticate the supply item by: determining a plurality of feature values of the supply item, each feature value corresponding to a respective one of the feature types, inputting the feature values to the model, and determining the supply item to be authentic based on a comparison of the confidence value with a predetermined threshold.

In certain implementations, the model is a machine learning model. In certain implementations, the model is a classifier, such as a multi-layer perceptron. In certain implementations, the feature types comprise properties of the supply item. In certain implementations, the feature types comprise results of tests performed by the supply item. In certain implementations, the feature types comprise a voltage of a chip of the supply item in predetermined circumstances. In certain implementations, the feature types comprise a time taken for a chip of the supply item to perform a predetermined task.

In certain implementations, the training data is collected from a plurality of test supply items including authentic and non-authentic supply items and each set of feature values in the training data is labelled as authentic or non-authentic. In certain implementations, each set of feature values in the training data is also labelled with a type of supply item (e.g. color of cartridge).

In certain implementations, the model is a classifier. In certain implementations, the classifier comprises a neural network, such as a multi-layer perceptron. In certain implementations, the classifier reduces loss to determine a probability that the supply item is genuine. In certain implementations, the classifier is configured to determine a type of supply. Using a multi-layer perceptron is advantageous because this type of model requires a relatively small amount of processing power and is a relatively simple model. In certain implementations, the model is stored on the imaging device.

In certain implementations, the method further comprises sending the feature values of the supply item to a central system, for example, via a network, such as the internet. In certain implementations, the method further comprises retraining the model, optionally, periodically. In certain implementations, the method further comprises receiving, by the imaging device, an updated model and replacing the model with the updated model. Retraining may be performed by a model-training computing device, such as a computer, server, or cloud-based system.

In certain implementations, the model is an anomaly detecting model. In certain implementations, the model is an autoencoder model. In certain implementations, the anomaly detecting model is configured to compress the feature values, reconstruct the compressed feature values and determine a confidence value indicating a likelihood that the reconstructed feature values originate from an authentic supply item. In certain implementations, the anomaly detection model is configured to determine a likelihood of the reconstructed feature values originating from one or more of: the supply item, a genuine supply item, a tampered supply item and/or a non-authentic supply item.

In certain implementations, the training data is collected from the supply item during manufacturing of the supply item. The likelihood of the reconstructed feature values originating from the supply item can be considered to be the likelihood of the supply item being authentic, because this indicates that the supply item stores a model that corresponds to the feature values of the supply item. The model may be considered a unique identifier of the supply item as the weights for each feature type may be specific to the supply item.

In certain implementations, the training data is collected during multiple instances of testing the supply item during manufacturing. Training may be performed by a model-training computing device, such as a computer, server, or cloud-based system.

In certain implementations, determining a plurality of feature values of the supply item comprises: reading the model from the supply item by the imaging device, determining the feature types of the model by the imaging device, and reading the feature values corresponding to the determined feature types from the supply item by the imaging device.

In certain implementations, the model and feature types are stored on the supply item. In certain implementations, determining the feature types comprises reading the feature types from metadata associated with the model on the supply item. In certain implementations, reading the feature values comprises measuring the feature values of the supply item and/or running tests on the supply item and determining the results of the tests.

In certain implementations, the steps of inputting the feature values to the model and determining the supply item to be authentic based on the comparison of the confidence value with the predetermined threshold, are performed by the imaging device.

In certain implementations, authenticating the supply item further comprises: receiving a cryptographic signature from the supply item, verifying the signature with a public key and verifying the model with the signature. In certain implementations, the signature contains an indication of an expected range of feature values for the supply item.

There is provided a method of generating a unique identifier for a supply item, the method comprising: performing a plurality of instances of testing on the supply item, each instance of testing comprising determining a plurality of feature values of the supply item, each feature value corresponding to a respective feature type, recording the determined feature values for each instance of testing as training data, training a model, using the training data, to determine a confidence value indicating a likelihood that input feature values originate from the supply item, the model comprising a weight corresponding to each feature type.

The optional features described above apply equally to this method. In particular, in certain implementations, the model is a machine learning model, such as an anomaly detecting model, such as an autoencoder model. In certain implementations, the feature types comprise properties or results of tests.

In certain implementations, determining a plurality of feature values of the supply item comprises: reading the model from the supply item by the imaging device, determining the feature types of the model by the imaging device, and reading the feature values corresponding to the determined feature types from the supply item by the imaging device. In certain implementations, the model and feature types are stored on the supply item.

In certain implementations, the method further comprises: authenticating the supply item when installed in an imaging device, using a method of authenticating a supply item as described above.

In certain implementations, the method further comprises storing the unique identifier on a memory of the supply item. In certain implementations, the method further comprises generating a signature of the unique identifier and storing the signature on a memory of the supply item.

There is provided a supply item comprising a memory, the memory storing a unique identifier, the unique identifier comprising a list of feature types of the supply item and a model configured to return a confidence value that feature values input to the model originate from the supply item, wherein each feature value corresponds to a respective one of the feature types, and wherein the model comprises a plurality of weights, each weight corresponding to a respective one of the feature types.

In certain implementations, the memory further stores a cryptographic signature based on the unique identifier. In certain implementations, the supply item is an imaging device supply item.

The optional features described above apply equally to this supply item. In particular, in certain implementations, the model is a machine learning model, such as an anomaly detecting model, such as an autoencoder model. In certain implementations, the feature types comprise properties or results of tests.

There is further provided an imaging device, the imaging device configured to authenticate a supply item when the supply item is installed in the imaging device by: determining a plurality of feature values of the supply item, each feature value corresponding to a respective feature type, inputting the feature values to a model, wherein the model comprises a respective weight for each of the feature types and the model is configured to return a confidence value, the confidence value indicating a likelihood that the supply item is authentic, and determining the supply item to be authentic based on a comparison of the confidence value with when the confidence value is greater than a predetermined threshold. The optional features described above apply equally to this imaging device. In particular, the model may be stored on the imaging device. In certain implementations, the imaging device may be configured to retrieve or receive the model from the supply item.

There is provided a method of authenticating a supply item installed in an electronic device, the method comprising: determining a plurality of feature values of the supply item, each feature value corresponding to a respective feature type, inputting the feature values to a model, wherein the model comprises a respective weight for each of the feature types and the model is configured to return a confidence value, the confidence value indicating a likelihood that the supply item is authentic, and determining the supply item to be authentic based on a comparison of the confidence value with a predetermined threshold.

There is further provided an electronic system, the electronic system comprising an electronic device and a supply item installed in the electronic device, wherein the electronic device stores a model, wherein the model comprises a respective weight for each of a plurality of feature types and the model is configured to return a confidence value, the confidence value indicating a likelihood that the supply item is authentic, and the imaging device is configured to authenticate the supply item by: determining a plurality of feature values of the supply item, each feature value corresponding to a respective one of the feature types, inputting the feature values to the model, and determining the supply item to be authentic based on a comparison of the confidence value with a predetermined threshold.

There is provided a method of generating a unique identifier for a supply item, the method comprising: performing a plurality of instances of testing on the supply item, each instance of testing comprising determining a plurality of feature values of the supply item, each feature value corresponding to a respective feature type, recording the determined feature values for each instance of testing as training data, training a model, using the training data, to determine a confidence value indicating a likelihood that input feature values originate from the supply item, the model comprising a weight corresponding to each feature type.

There is provided a supply item comprising a memory, the memory storing a unique identifier, the unique identifier comprising a list of feature types of the supply item and a model configured to return a confidence value that feature values input to the model originate from the supply item, wherein each feature value corresponds to a respective one of the feature types, and wherein the model comprises a plurality of weights, each weight corresponding to a respective one of the feature types.

There is further provided an electronic device, the electronic device configured to authenticate a supply item when the supply item is installed in the electronic device by: determining a plurality of feature values of the supply item, each feature value corresponding to a respective feature type, inputting the feature values to a model, wherein the model comprises a respective weight for each of the feature types and the model is configured to return a confidence value, the confidence value indicating a likelihood that the supply item is authentic, and determining the supply item to be authentic based on a comparison of the confidence value with when the confidence value is greater than a predetermined threshold.

The optional features described above in relation to the method of authenticating a supply item installed in an imaging device, the imaging system, the method of generating a unique identifier for a supply item, the supply item and the imaging device apply equally to each of the method of authenticating a supply item installed in an electronic device, electronic system, method of generating a unique identifier for a supply item, supply item and electronic device.

In this application, a controller may comprise printer/imaging device System-on-Chip (SoC), non-volatile memory containing firmware, and/or a system security device which may also be referred to as an imaging device security device and/or a security device of the controller. The imaging device security device may perform some or all of the actions referred to as performed by the imaging device. The system security device may perform some or all of the actions described as performed by the controller. Each supply item may comprise a respective supply item security device and the supply item security devices may perform some or all of the actions described as performed by the supply items.

In certain implementations, the supply items may each be a toner cartridge, imaging unit or a fuser or another type of supply item.

In any of the implementations/embodiments described herein, the components may be connected via any shared bus, such as I2C or peer-to-peer.

The methods, devices, supply items and systems described above may be employed in any combination. The optional features described above are equally applicable to all of the described methods, devices, supply items and systems and are not limited to the particular method/device/supply item/system with which they are described. The essential features of any of the methods/devices/supply items/systems described may be optional features of any other method/device/supply item/system described.

From the foregoing disclosure and the following detailed description of various examples, it will be apparent to those skilled in the art that the present disclosure provides a significant advance in the art of determining the authenticity of a component an electronic system. Additional features and advantages of various examples will be better understood in view of the detailed description provided below.

As used herein, the term ‘leader’ is equivalent to the term ‘master’ and can be used interchangeably throughout without changing the meaning. As used herein, the term ‘follower’ is equivalent to the term ‘slave’ and can be used interchangeably throughout without changing the meaning. Both terms ‘master’ and ‘slave’ take their usual meanings in the art, for example, as used in the official I2C specification.

### BRIEF DESCRIPTION OF THE DRAWINGS

The above-mentioned and other features and advantages of the present disclosure, and the manner of attaining them, will become more apparent and will be better understood by reference to the following description of examples taken in conjunction with the accompanying drawings. Like reference numerals are used to indicate the same element throughout the specification.

FIG. 1 is a diagrammatic view of an imaging system;

FIG. 2A is a flow chart showing the training of a machine learning model for determining a likelihood that a supply item is authentic;

FIG. 2B is a flow chart showing a method of authenticating a supply item using the machine learning model of FIG. 2A;

FIG. 3 is a schematic diagram showing an imaging device security device configured to perform the method of FIG. 2B;

FIG. 4A is a flow chart showing the training of a machine learning model for determining a likelihood that a supply item is authentic;

FIG. 4B is a flow chart showing a method of authenticating a supply item using the machine learning model of FIG. 4A.

### DETAILED DESCRIPTION OF THE DRAWINGS

It is to be understood that the disclosure is not limited to the details of construction and the arrangement of components set forth in the following description or illustrated in the drawings. The disclosure is capable of other examples and of being practiced or of being carried out in various ways. For example, other examples may incorporate structural, chronological, process, and other changes. Examples merely typify possible variations. Individual components and functions are optional unless explicitly required, and the sequence of operations may vary. Portions and features of some examples may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced items.

In addition, it should be understood that examples of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto an imaging device and/or an electronic device, a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps or combinations of special purpose hardware and computer instructions.

Disclosed are example systems, devices and methods for determining the authenticity of a component in an electronic system, such as an imaging system such as a printer.

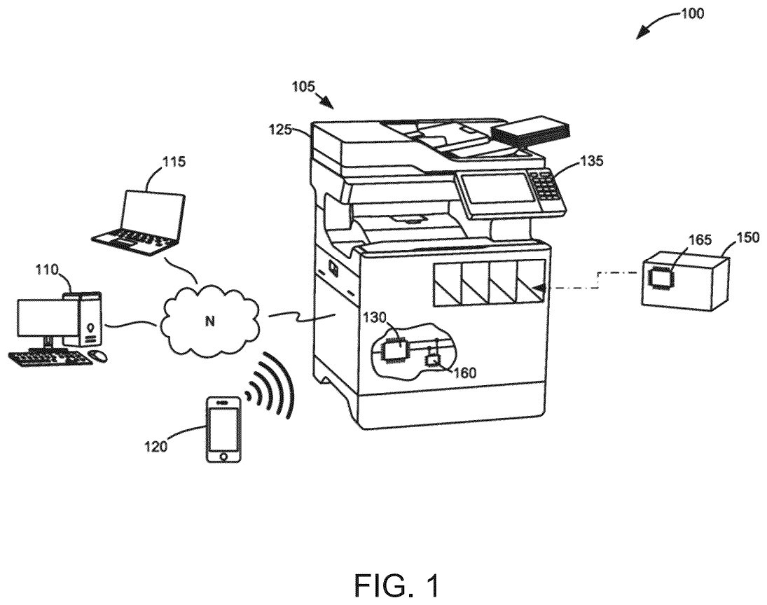

Referring to FIG. 1, there is shown a diagrammatic view of an imaging system 100 used in association with the present disclosure. Imaging system 100 includes an imaging device 105 used for printing images on sheets of media. Image data of the image to be printed on a media sheet may be supplied to imaging device 105 from a variety of sources such as a computer 110, laptop 115, mobile device 120, scanner 125 of the imaging device 105, or like computing device. The sources directly or indirectly communicate with imaging device 105 via wired and/or wireless connections.

Imaging device 105 includes an imaging device component 130 and a user interface 135. The imaging device controller may include component 130 which may include a processor and associated memory. In some examples, imaging device component 130 may be formed as one or more Application Specific Integrated Circuits (ASICs) or System-on-Chip (SoCs). Memory may be any memory device which stores data and may be used with or capable of communicating with a processor. For example, memory may be any volatile or non-volatile memory or combination thereof such as, for example, random access memory (RAM), read-only memory (ROM), flash memory and/or non-volatile RAM (NVRAM) for storing data. Optionally, imaging device component 130 may control the processing of print data. Optionally, imaging device component 130 may also control the operation of a print engine during printing of an image onto a sheet of media.

In one example, imaging device 105 may employ an electronic authentication scheme to authenticate consumable supply items and/or replaceable units installed in imaging device 105. In FIG. 1, a representative consumable supply item/replaceable item, such as a toner cartridge 150, is shown (other consumable/replaceable supply items can equally be used in addition or instead, such as imaging units and fusers). Supply item 150 may be installed in a corresponding storage area in imaging device 105. To perform authentication of supply item 150, imaging device 105 may utilize an imaging device security device 160 incorporated in imaging device 105 and a supply item security device 165 of supply item 150.

In one example, imaging device security device 160 in imaging device 105 may be similar to or the same as supply item security device 165 in consumable supply item 150. Optionally, the imaging device security device 160 may be programmed differently from supply item security device 165. Imaging device security device 160 and supply item security device 165 may operate in conjunction with one another to perform authentication functions, as will be explained in greater detail below.

The supply item security device 165 comprises a processor and hardware encryption components. A plurality of the hardware encryption components may be located on the same chip. In other embodiments, one or more of these hardware components may be omitted.

The imaging device security device 160 may also comprise a processor and hardware encryption components. In other embodiments, one or more of these hardware chips may be omitted. The supply item security device 165 and the imaging device security device 160 may have the same components.

The imaging device 105 may attempt to authenticate a supply item 150 at any point, for example, at fixed time intervals. Additionally/alternatively, the imaging device 105 may attempt to authenticate supply item 150 shortly after a Power On Reset (POR) or shortly after the supply item 150 is installed in the imaging device.

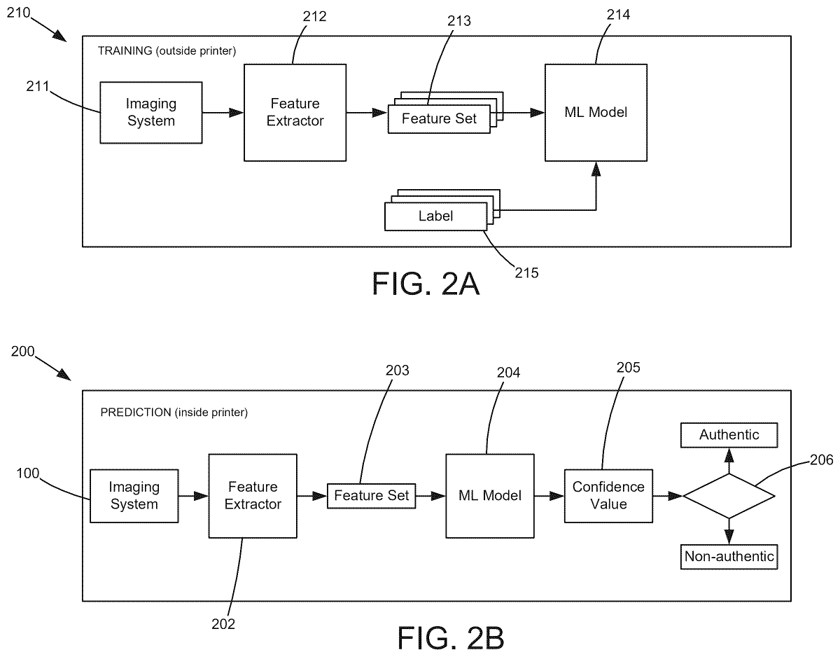

FIG. 2B shows a method 200 of authenticating a supply item 150 installed in an imaging device 105 in imaging system 100.

The method comprises, at step 202, determining a plurality of feature values of the supply item 150. Each feature value corresponds to a respective feature type and the set of feature values is formed into a set of feature values 203.

The feature types comprise properties of the supply item 150 that can be measured by the imaging device 105. The properties comprise one or more electrical properties of the supply item, such as electrical properties of a security chip/device on the supply item.

In the present embodiment, the feature types comprise a voltage level in predetermined circumstances, a time taken to perform a predetermined task and a challenge response. Each of the feature values of the supply item are measured by firmware on the imaging device.

At step 204, the set of feature values 203 are input to a model. The model is a machine learning model and FIG. 2A shows a method 210 of training the model.

Steps 211, 212, 213 and 215 of FIG. 2A show the collection of training data from a plurality of different imaging systems, such as imaging system 100. The imaging systems each include a test supply item, some of which are authentic and some of which are non-authentic supply items. Multiple imaging devices are utilized in testing including imaging devices with differing properties, such as age and/or model number and/or functionality. Imaging systems with differing functionality may include (i) single-function and multi function systems, (ii) printers with integrated scanners and printers without integrated scanners, (iii) systems with different print speeds, and (iv) printers with different user interfaces. At step 212, feature values for each feature type are determined for each imaging system during testing of the imaging systems 211. The feature values are generated from real-life testing of the imaging systems in step 211. The testing includes putting the imaging systems and/or supply items in the imaging systems under boundary/edge conditions. The testing includes simulating fast and slow corners of the imaging system by adjusting the system capacitance and/or using corner parts of a chip of a security device of the imaging device or supply item. The corner parts represent the extreme edges of the manufacturing process of a silicon device.

The training data 213 comprises sets of feature values. Each set of feature values contains feature values from a single respective supply item from the imaging systems 211. Each set comprises a feature value for each of the feature types.

At step 215, each set of feature values in the training data is labelled as authentic or non-authentic according to the authenticity of the supply item used on the respective instance of testing. Optionally, each set of feature values in the training data may also be labelled with a type of supply item (e.g. color of cartridge).

At step 214, the model is trained using supervised learning with labelled sets of feature values. The model is a multi-layer perceptron classifier. The classifier is configured to reduce loss to determine a probability that the supply item is genuine. The model, once complete, is stored on the imaging device 105.

The model comprises a respective weight for each of the feature types and the model is configured to return a confidence value, the confidence value indicating a likelihood that the supply item is authentic at step 205. In this example, the confidence value is lower when the likelihood of authenticity is greater.

In certain implementations, the method is performed by firmware on the imaging device and/or supply item.

Returning to FIG. 2B and the method 200 of authenticating a supply item 150, at step 206, the supply item is determined to be authentic when the confidence value is less than a predetermined threshold, indicating that the supply item is likely to be authentic. When the confidence value is the same as, or above the threshold, the supply item is determined to be non-authentic. The imaging system may then take further action, such as initiating further countermeasures to check the authenticity of the supply item or preventing use of the supply item.

The imaging device 105 sends the feature values of the supply item 150 to a central system, via network N and the internet. The central server receives information from many imaging systems and may retrain the model, optionally, periodically, or in response to a newly identified non-authentic supply item.

When retraining has occurred, the central server sends the updated model to the imaging device 105, via the internet and the network N. The imaging device 105 receives the updated model and replaces the model with the updated model.

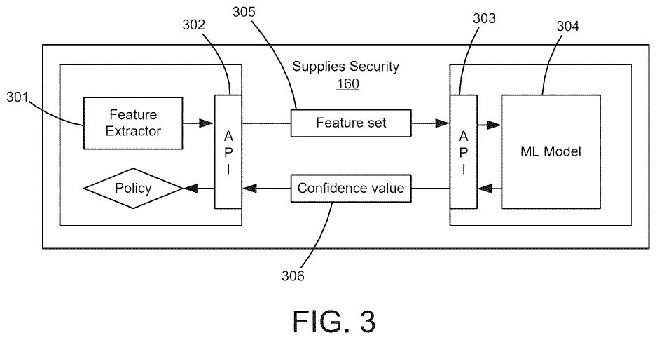

FIG. 3 shows an example of components on imaging device security device 160. Feature extractor 301 receives communication from the supply item 150, via the imaging system communication system, which may be an I2C bus. The feature extractor 301 then determines the feature values to produce the set of feature values 305. Using APIs 302 and 303, the set of features 305 is input to the model 304. The model 304 returns the confidence value 306 via APIs 302 and 303 and a determination is made as to the authenticity of the supply item 150, based on the confidence value 306.

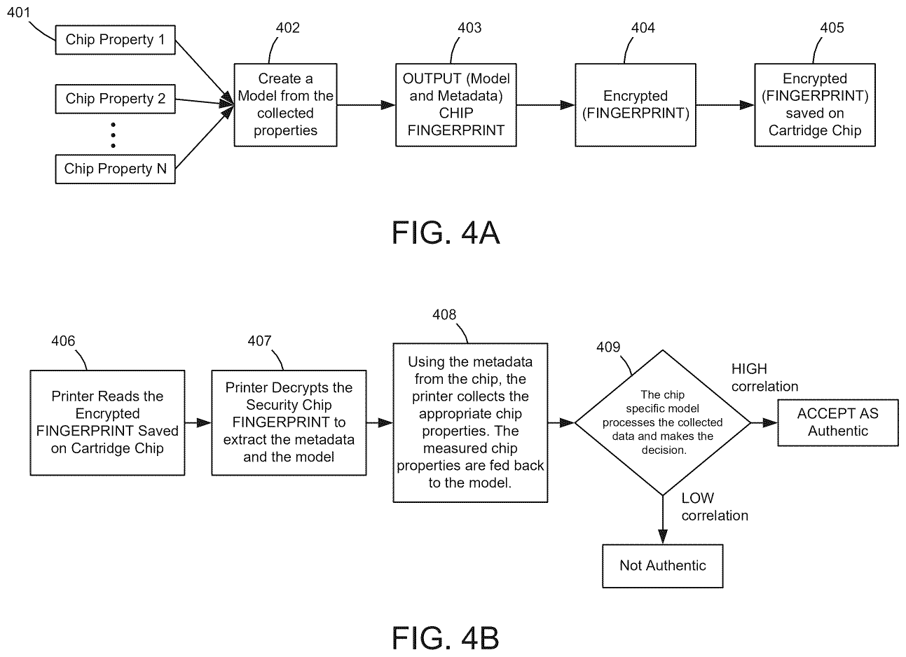

In another embodiment, as will be described below with reference to FIG. 1 and FIGS. 4A and 4B, a method of authenticating a supply item installed in an imaging device is provided.

This method involves generating a unique identifier for a supply item 150 as shown in FIG. 4A and authenticating the supply item 150 when installed in imaging device 105 as described in FIG. 4B.

In step 401 of FIG. 4A training data is generated by real-life testing of the supply item 150 during manufacturing of the supply item 150. A plurality of sets of feature values of the supply item 150 are determined, each feature value within a set corresponding to a respective feature type. Each set of feature values is determined by performing a respective instance of testing on the supply item. Each instance of testing comprises determining and recording the feature values. The plurality of sets of feature values are recorded as training data. The training data includes data collected under boundary/edge conditions and/or includes tolerance data. The testing utilizes multiple imaging systems including imaging systems with differing properties, such as age and/or model number and/or functionality. Imaging systems with differing functionality may include (i) single-function and multi function systems, (ii) printers with integrated scanners and printers without integrated scanners, (iii) systems with different print speeds, and (iv) printers with different user interfaces. The feature types each comprise a respective different characteristic, such as a property or test result of the supply item.

The training data is received by a model-training computing device, such as a computer, server, or cloud-based system. Training comprises supervised learning, and/or transfer learning. As all of the training data originates from the supply item 150, explicit labels are not required.

Step 402 comprises training a model, using the training data, to determine a confidence value indicating a likelihood that input feature values originate from the supply item 150, the model comprising a weight corresponding to each feature type. Training is carried out by the model-training computing device.

The model is an autoencoder model and, in this embodiment, the feature types comprise a voltage level in predetermined circumstances, a time taken to perform a predetermined task and a challenge response. Other features may be used in other embodiments.

The autoencoder model is configured to compress the feature values, reconstruct the compressed feature values and determine a confidence value indicating a likelihood that the reconstructed feature values originate from the supply item 150.

In step 403, the model and metadata including a list of feature types of the supply item used in the model are compiled to form the unique identifier.

In step 404, the unique identifier is encrypted and then in step 405, the encrypted unique identifier is saved on a memory of the supply item 150. The combination of the model and metadata is considered a unique identifier of the supply item as the weights for each feature type may be specific to the supply item. Steps 404 and 405 may be performed by an imaging device or other computing device in communication with the supply item 150.

FIG. 4B shows a method of authenticating the supply item 150 installed in imaging device 105. The supply item 150 has the unique identifier stored on a memory.

At step 406, the imaging device 105 reads the unique identifier from the supply item 150 and decrypts the unique identifier at step 407.

At step 408, the imaging device determines the feature types of the model by reading the metadata and reads/measures the feature values corresponding to the determined feature types from the supply item.

At step 409, the imaging device inputs the feature values to the model in the unique identifier. The model returns a confidence value, the confidence value indicating a likelihood that the supply item is the supply item 150.

The supply item 150 is determined to be authentic when the confidence value is less than a predetermined threshold. A low confidence value indicates a high probability that the feature values measured/read by the imaging device originated from the supply item 150. The likelihood of the reconstructed feature values originating from the supply item can be considered to be the likelihood of the supply item being authentic, because this indicates that the supply item stores a model that corresponds to the feature values of the supply item.

When the confidence value is equal to or greater than the threshold, the supply item is determined to be non-authentic and/or further action may be taken, such as initiating further countermeasures to check the authenticity of the supply item. For example, the imaging device may prevent use of the supply item, when it is determined that the supply item is non-authentic.

In certain implementations, the method is performed by firmware on the imaging device and/or supply item.

The above has been described in relation to a specific implementation/embodiment. However, modifications can be implemented within the scope of the application, some of which are detailed below.

In the above implementations/embodiments, the various components are configured as leader/follower components. This is purely optional and other communication buses may be used.

Relatively apparent advantages of the many embodiments include, but are not limited to, providing an authentication system/method which is more difficult to satisfy/replicate due to the role of the verifier supply item in the authentication process.

It will be understood that the example applications described herein are illustrative and should not be considered limiting. It will be appreciated that the actions described and shown in the example flowcharts may be carried out or performed in any suitable order. It will also be appreciated that not all of the actions described in FIGS. 2A, 2B, 4A and 4B need to be performed in accordance with the example embodiments of the disclosure and/or additional actions may be performed in accordance with other example embodiments of the disclosure. It will also be appreciated that the method may be applied to any electronic device and is not limited to the context of the imaging device with which it has been described.

Many modifications and other embodiments of the disclosure set forth herein will come to mind to one skilled in the art to which these disclosures pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Further disclosure is provided below.
Statement 1: A method of generating a unique identifier for a supply item, the method comprising:
performing a plurality of instances of testing on the supply item, each instance of testing comprising determining a plurality of feature values of the supply item, each feature value corresponding to a respective feature type,
recording the determined feature values for each instance of testing as training data, and
training a model, using the training data, to determine a confidence value indicating a likelihood that input feature values originate from the supply item, the model comprising a weight corresponding to each feature type.
Statement 2: The method of statement 1, wherein the model is a machine learning model.
Statement 3: The method of statement 2, wherein the model is an autoencoder model.
Statement 4: The method of statement 1, wherein the feature types comprise properties of the supply item.
Statement 5: The method of statement 1, wherein the feature types comprise results of tests performed by the supply item.
Statement 6: The method of statement 4, wherein the feature types comprise a voltage of a chip of the supply item in predetermined circumstances.
Statement 7: The method of statement 5, wherein the feature types comprise a time taken for a chip of the supply item to perform a predetermined task.
Statement 8: The method of statement 1, wherein determining a plurality of feature values of the supply item comprises:
reading the model from the supply item by an imaging device in which the supply item is installed,
determining the feature types of the model by the imaging device, and reading the feature values corresponding to the determined feature types from the supply item by the imaging device.
Statement 9: The method of statement 1, further comprising: authenticating the supply item when installed in an imaging device, authenticating the supply item comprising:
determining the plurality of feature values of the supply item,
inputting the feature values to the model, and
determining the supply item to be authentic based on a comparison of the confidence value with a predetermined threshold.
Statement 10: The method of statement 9, wherein authenticating the supply item further comprises: receiving a cryptographic signature from the supply item, verifying the signature with a public key and verifying the unique identifier with the signature.
Statement 11: The method of statement 10, wherein the steps of inputting the feature values to the model and determining the supply item to be authentic based on a comparison of the confidence value with a predetermined threshold, are performed by the imaging device.
Statement 12: The method of statement 1, wherein the method further comprises storing the unique identifier on a memory of the supply item.
Statement 13: The method of statement 1, wherein the method further comprises generating a signature of the unique identifier and storing the signature on a memory of the supply item.
Statement 14: A supply item comprising a memory, the memory storing a unique identifier, the unique identifier comprising a list of feature types of the supply item and a model configured to return a confidence value that feature values input to the model originate from the supply item, wherein each feature value corresponds to a respective one of the feature types, and wherein the model comprises a plurality of weights, each weight corresponding to a respective one of the feature types.
Statement 15: The supply item of statement 14, wherein the model is a machine learning model.
Statement 16: The supply item of statement 15, wherein the model is an autoencoder model.
Statement 17: The supply item of statement 14, wherein the feature types comprise properties of the supply item.
Statement 18: The supply item of statement 14, wherein the feature types comprise results of tests performed by the supply item.
Statement 19: The supply item of statement 14, wherein the feature types comprise a voltage of a chip of the supply item in predetermined circumstances, or a time taken for a chip of the supply item to perform a predetermined task.
Statement 20: The supply item of statement 14, wherein the memory further stores a cryptographic signature based on the unique identifier.

What is claimed is:

1. A method of authenticating a supply item installed in an imaging device, the method comprising:
determining a plurality of feature values of the supply item, each feature value corresponding to a respective feature type,
inputting the feature values to a model, wherein the model comprises a respective weight for each of the feature types and the model is configured to return a confidence value, the confidence value indicating a likelihood that the supply item is authentic, and
determining the supply item to be authentic based on a comparison of the confidence value with a predetermined threshold.

2. The method of claim 1, wherein the model is a machine learning model, and the method further comprises training the model using training data comprising sets of feature values, wherein each set contains feature values from a single respective supply item.

3. The method of claim 2, wherein the model is an autoencoder model.

4. The method of claim 2, wherein the training data is collected from the supply item during manufacturing of the supply item.

5. The method of claim 4, wherein the training data is collected during multiple instances of testing the supply item during manufacturing.

6. The method of claim 1, wherein determining a plurality of feature values of the supply item comprises:
reading the model from the supply item by the imaging device,
determining the feature types of the model by the imaging device, and
reading the feature values corresponding to the determined feature types from the supply item by the imaging device.

7. The method of claim 1, wherein the steps of inputting the feature values to the model and determining the supply item to be authentic based on comparison between the confidence value and the predetermined threshold, are performed by the imaging device.

8. The method of claim 2, wherein the training data is collected from a plurality of test supply items including authentic and non-authentic supply item(s) and each set of feature values in the training data is labelled as authentic or non-authentic.

9. The method of claim 2, wherein the model is a classifier.

10. The method of claim 1, wherein the feature types comprise properties of the supply item.

11. The method of claim 1, wherein the feature types comprise results of tests performed by the supply item.

12. The method of claim 10, wherein the feature types comprise a voltage of a chip of the supply item in predetermined circumstances.

13. The method of claim 11, wherein the feature types comprise a time taken for a chip of the supply item to perform a predetermined task.

14. An imaging system, the imaging system comprising an imaging device and a supply item installed in the imaging device,
wherein the imaging device stores a model, wherein the model comprises a respective weight for each of a plurality of feature types and the model is configured to return a confidence value, the confidence value indicating a likelihood that the supply item is authentic, and
the imaging device is configured to authenticate the supply item by:
determining a plurality of feature values of the supply item, each feature value corresponding to a respective one of the feature types,
inputting the feature values to the model, and
determining the supply item to be authentic based on a comparison of the confidence value with a predetermined threshold.

15. The imaging system of claim 14, wherein the model is a machine learning model.

16. The imaging system of claim 14, wherein the model is a classifier.

17. The imaging system of claim 14, wherein the feature types comprise properties of the supply item.

18. The imaging system of claim 14, wherein the feature types comprise results of tests performed by the supply item.

19. The imaging system of claim 17, wherein the feature types comprise a voltage of a chip of the supply item in predetermined circumstances.

20. The imaging system of claim 18, wherein the feature types comprise a time taken for a chip of the supply item to perform a predetermined task.
